(19) United States
(12) Patent Application Publication
(10) Pub. No.: US 2018/0136514 A1
(43) Pub. Date: May 17, 2018

(54) LIQUID CRYSTAL DISPLAY ASSEMBLY

(71) Applicant: Structo Pte Ltd, Singapore (SG)

(72) Inventors: Hubertus Theodorus Petrus van Esbroeck, Singapore (SG); Devansh Sharma, Singapore (SG); Siu Hon Lam, Singapore (SG); Kah Fai Chin, Singapore (SG)

(21) Appl. No.: 15/574,398

(22) PCT Filed: May 12, 2016
(86) PCT No.: PCT/SG2016/050224

§ 371 Date: Nov. 15, 2017

(30) Foreign Application Priority Data
May 18, 2015 (GB) 1508520.2

(51) Int. Cl. G02F 1/1335; G02F 1/1333; F26B 3/30; F26B 3/28

(52) U.S. Cl. CPC G02F 1/133528; G02F 1/133382; G03B 21/006; F26B 3/28; G02F 2001/133531; F26B 3/30

(57) ABSTRACT

A liquid crystal display assembly, comprising: a first substrate, a second substrate and a liquid crystal layer intermediate the first substrate and the second substrate; a first polarizer having an inner surface which faces towards the first substrate, and an outer surface; and a second polarizer disposed on the second substrate and having a plane of polarization orthogonal to that of the first polarizer; wherein the inner surface of the first polarizer is spaced from the first substrate such that the inner surface and/or the outer surface is exposed to enable convective cooling thereof.

### TECHNICAL FIELD

This invention relates to a liquid crystal display (LCD) assembly and to a method of arranging components of a LCD assembly. Embodiments are useful in applications such as LCD-based projectors and stereolithography apparatus, although it will be appreciated that the invention may also be employed in other contexts.

### BACKGROUND

Liquid crystal displays (LCDs) typically comprise a liquid crystal material sandwiched between a pair of glass filters. Each glass filter has disposed thereon a sheet of polarizing material. The sheets have respective planes of polarization which are perpendicular to each other.

The polarizers used in LCDs are typically absorptive polarizers, for example composed of iodine-doped PVA. This gives high extinction ratios and hence high contrast. Due to this property of the polarizers, when the intensity of radiation used for backlighting the LCD is increased the amount of light absorbed by the polarizer increases proportionally. This is typically not a problem for LCDs being used as display screens, such as for desktop or laptop computers, because the intensity of light falling on the LCD polarizer is relatively small. However, for applications where the light intensity is much greater (in the order of tens to hundreds of watts/cm²), the backlight intensity is enough to cause a significant rise in temperature. This problem is also magnified in cases where light having wavelengths between 380 nm-420 nm is incident on the LCD. Due to the shorter wavelengths, the light readily scatters and gets absorbed by the polarizer sheet. High intensity light carries more energy per photon and this energy is converted to heat when absorbed by the polarizer. The temperature, which depends on the intensity and wavelength of the incident light, can increase to above the operating temperature of the liquid crystal panel. In such scenarios the liquid crystals may permanently transform into their liquid state and fail to change the polarization of incident light when subjected to an electric current, thus effectively failing to perform their function.

For example, in LCD-based projectors where hundreds of watts of light is focused on three small LCDs inside the projector which are less than an inch in size, there is a very small region of concentrated energy, approximately 50 percent of which gets absorbed by the polarizers. The absorbed energy is converted to heat, thereby subjecting the LCD panel to heat. These projectors have cooling devices to control temperature, but their effectiveness is limited by the space in the projector, and the degree to which cooling can be implemented is limited by the noise level which is acceptable during operation. Overheating is a common mode of failure in projectors.

Another situation in which heating of an LCD can be problematic is in additive manufacturing processes in which UV-backlit LCDs project successive images onto photopolymer resin to cure the resin layer by layer to form a three dimensional object. The LCD display in this case is mounted on a thick transparent backing formed from a plastics material. The transparent backing prevents effective cooling of the LCD because it is a poor conductor of heat. In this type of additive manufacturing device, the light intensity falling on the LCD is lower than that in LCD projectors, but the light lies almost entirely in the UV spectrum and is absorbed easily by the polarizer, thus raising the temperature significantly.

Previously, both active and passive cooling methods have been considered in order to address the heating problem. For example, U.S. Pat. No. 7,123,334 implements a water jacket over each LCD panel in an LCD projector to cool the panels. However, water cooling has disadvantages including water leakage, the requirement to change the water periodically, and bulkiness of the cooling assembly. In another example, a fan internal to the housing of the LCD projector can be used for convective cooling of the panels. However, since LCD projectors require a small form factor, it is difficult to install a fan which is big enough to provide the necessary air flow rate and which also is not so noisy that it affects audio quality when the projector is being used for home entertainment, for example.

In view of the above difficulties, it would be desirable to provide an LCD assembly which is more susceptible to cooling, or which at least provides a useful alternative to known LCD assemblies.

### SUMMARY

In one aspect, there is provided a liquid crystal display assembly, comprising:
a first substrate, a second substrate and a liquid crystal layer intermediate the first substrate and the second substrate;
a first polarizer having an inner surface which faces towards the first substrate, and an outer surface; and
a second polarizer disposed on the second substrate and having a plane of polarization orthogonal to that of the first polarizer;
wherein the inner surface of the first polarizer is spaced from the first substrate such that the inner surface and/or the outer surface is exposed to enable convective cooling thereof.

Advantageously, by spacing the inner surface of the first polarizer from the first substrate, a greater surface area of the first polarizer is exposed, thus facilitating convective cooling when the first polarizer is subjected to radiation, and reducing the likelihood of degradation of the liquid crystal layer.

The first polarizer may be completely separated from the remainder of the device such that there is an air gap between the first polarizer and the remainder of the device, and both the inner surface and the outer surface can then be subjected to convective cooling.

In some embodiments, for example when the liquid crystal display assembly is to be used as a dynamic mask in an additive manufacturing device, a rigid and transparent or translucent backing layer may be disposed on the first substrate. In such embodiments the first polarizer may be disposed on the transparent or translucent backing layer, or may be separated from it such that there is an air gap between the first polarizer and the transparent or translucent backing layer.

In some embodiments, the liquid crystal display assembly may comprise a third polarizer disposed on the first substrate, the third polarizer having the same plane of polarization as the first polarizer. The first polarizer may be a dichroic polarizer Advantageously, by providing the third polarizer with the same plane of polarization as the second polarizer, if the polarization of any light transmitted through the first polarizer is affected as the light propagates through the assembly, the third polarizer ensures that the light is re-polarized. This leads to a higher contrast ratio for the image produced by the LCD assembly.

In another aspect there is provided a curing assembly for a stereolithographic apparatus having a curing volume for containing a polymerisable material, the curing assembly comprising:
a liquid crystal display assembly according to any one of the above embodiments; and
a radiation source for irradiating the curing volume through the liquid crystal display assembly.

The curing assembly may comprise cooling means for convective cooling of the inner surface and/or the outer surface of the first polarizer of the liquid crystal display assembly.

In a further aspect there is provided a method of arranging components of a liquid crystal display assembly, the liquid crystal display assembly comprising a first substrate, a second substrate, a liquid crystal layer intermediate the first substrate and the second substrate, a first polarizer, and a second polarizer having a plane of polarization orthogonal to that of the first polarizer, the method comprising:
disposing the second polarizer on the second substrate; and
spacing the first polarizer from the first substrate whereby an inner surface of the first polarizer faces towards the first substrate, such that the inner surface and/or outer surface of the first polarizer is exposed to enable convective cooling thereof.

### BRIEF DESCRIPTION OF THE DRAWINGS

Embodiments of the invention will now be described, by way of non-limiting example only, with reference to the accompanying drawings in which:

FIG. 1 is a cross-sectional view through a prior art LCD assembly;

FIG. 2 is a cross-sectional view through an LCD assembly according to an embodiment of the invention;

FIG. 3 is a cross-sectional view through an LCD assembly according to another embodiment of the invention; and

FIG. 4 is a schematic diagram of an additive manufacturing apparatus having an LCD assembly according to embodiments of the invention.

### DETAILED DESCRIPTION OF EMBODIMENTS

Embodiments of the present invention seek to actively maintain the temperature of a liquid crystal panel under the specified operating temperature for the panel, especially in situations where the LCD is not directly accessible to conventional methods of cooling, namely, conduction and convection.

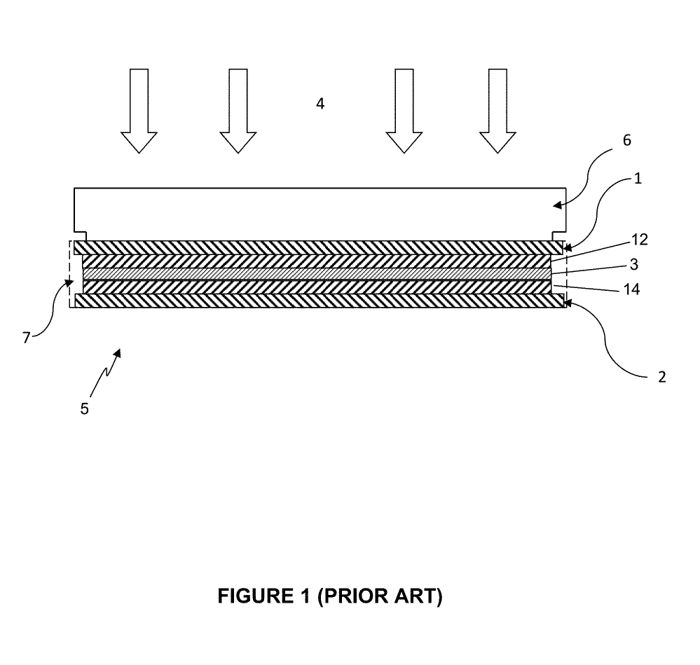

Referring to FIG. 1, there is shown a prior art LCD assembly 5 having an LCD panel 7 affixed to a rigid platform 6 which is transparent to electromagnetic radiation from the UV spectrum to the infrared spectrum. The platform 6 can be of any material which is rigid enough to prevent structural bending on the LCD glass 12, 14 when the assembly is subjected to vertical loads. The LCD panel 7 comprises a first polarizer 1 disposed on a first substrate 12. The first substrate 12 and a second substrate 14 sandwich a layer of a liquid crystal material 3. A second polarizer 2 is disposed on the second substrate 14. The first and second substrates 12, 14 serve to provide rigidity to the assembly, and may perform other functions as known in the art. For example, each substrate 12, 14 may be formed from glass and may have surface relief structures for aligning the liquid crystals 3. Typically, other layers are present, such as electrode layers and the like, and electronic components for allowing regions of the liquid crystal layer 3 to be electronically addressed (not shown). The first and second polarizers 1, 2 are dichroic polarizing films. The plane of polarization of the second polarizer 2 is perpendicular to that of the first polarizer 1.

The LCD assembly 5 is part of a curing assembly for an additive manufacturing machine. In use, the assembly 5 is positioned such that the second polarizer 2 faces towards a vessel in which a photopolymerisable resin is contained. A radiation source 4, which is capable of emitting high intensity electromagnetic radiation, for example in the UV part of the spectrum, the infrared part of the spectrum or somewhere in between, may be used to illuminate the assembly 5 through the transparent platform 6. When radiation source 4 is turned on and the LCD display is addressed to show a black and white image, LCD panel 7 lets radiation pass through in the white regions of the image while all radiation is blocked at the black regions of the image. Radiation which passes through the panel 7 impinges on resin inside the vessel, thus curing the resin. The LCD panel 7 thus acts as a dynamic mask to allow the resin to be cured in image-wise fashion.

The radiation which is not let through due to the “black” regions on the LCD gets absorbed by the polarizer 2 and subsequently raises the temperature of the LCD panel 7. It has been found in this arrangement that the LCD temperature can rise by 40 degrees under a few seconds of exposure. Generally this rise in temperature is controlled using direct cooling of the LCD panel 7 by convection, which can be achieved by blowing cool air at the back of the LCD 7, for example. However, in this arrangement the back of the LCD panel 7 is the mounting surface of the panel 7 to the platform 6 and hence convection cooling will no longer be effective since the LCD panel 7 is essentially inaccessible to the blower.

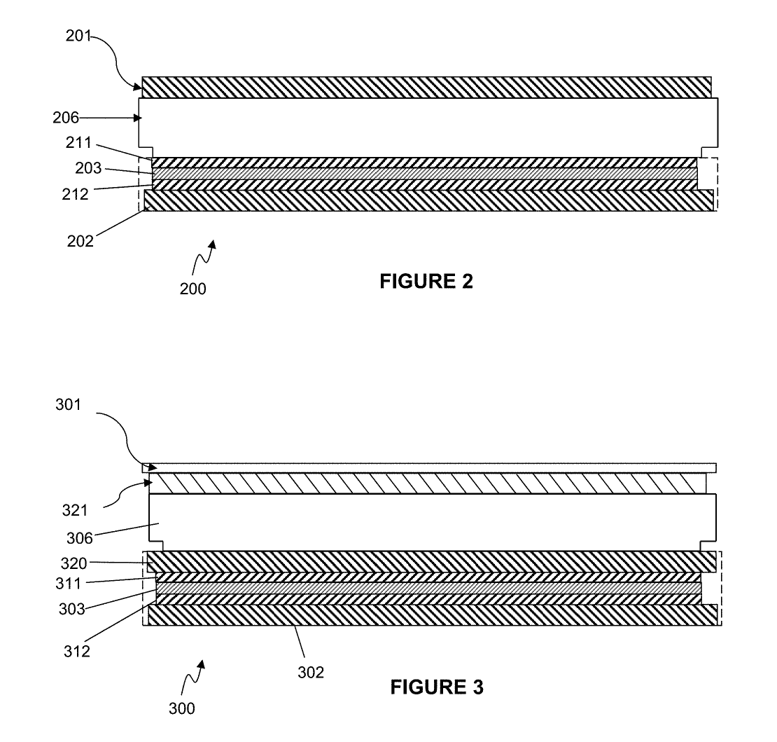

To alleviate the above problem, a first embodiment of the invention, which is shown in FIG. 2, spaces the first polarizer from the first substrate in a manner such that at least its outer surface is accessible to a convective cooling means such as a blower. The LCD assembly 200 shown in FIG. 2 comprises first polarizer 201, which is disposed on a rigid transparent support member 206, which is equivalent to the rigid support 6 of FIG. 1. The support member 206 is in turn disposed on a first substrate 211 (e.g., a glass substrate), which together with a second substrate 212 sandwiches a liquid crystal layer 203 (as well as other components which are standard in the art, such as electrodes and other electronic components). A second polarizer 202 is disposed on the second substrate 212. The direction of polarization of the second polarizer 202 is orthogonal to that of the first polarizer 201. Accordingly, the first polarizer 201 is effectively moved away from the remainder of the LCD panel 211, 203, 212, 202 such that the orientation of the polarizer 201 is maintained, the polarizer remains in the path of the incident radiation, and is able to be actively cooled by conventional cooling systems such as axial/centrifugal fans. This substantially reduces the amount of heat to which the liquid crystal layer 203 is subjected, since approximately half of the absorbed energy is absorbed by the first polarizer 201 if the incident light is unpolarized. This arrangement also allows for easy replacement of the polarizer 201 in the event that its polarization capability has been sufficiently degraded by the radiation to prevent it effectively functioning to polarize the incident radiation.

Another embodiment is shown in FIG. 3, in which a first polarizer 301 is disposed on a rigid transparent support member 306, equivalent to the rigid support 6 of FIG. 1 or 206 of FIG. 2. A layer of liquid crystal material 303 is sandwiched between a first substrate 311 and a second substrate 312. The first and second substrates 311, 312 are typically glass substrates as discussed above. The first polarizer 301 is spaced from the first substrate 311 by virtue of the intervening support member 306. A second polarizer 302 is disposed on the second substrate 312. The direction of polarization of the second polarizer 302 is orthogonal to that of the first polarizer 301. Additionally, a third polarizer 320 is disposed on the first substrate, intermediate the support member 306 and the first polarizer 301. The third polarizer 320 has the same direction of polarization as the first polarizer 301.

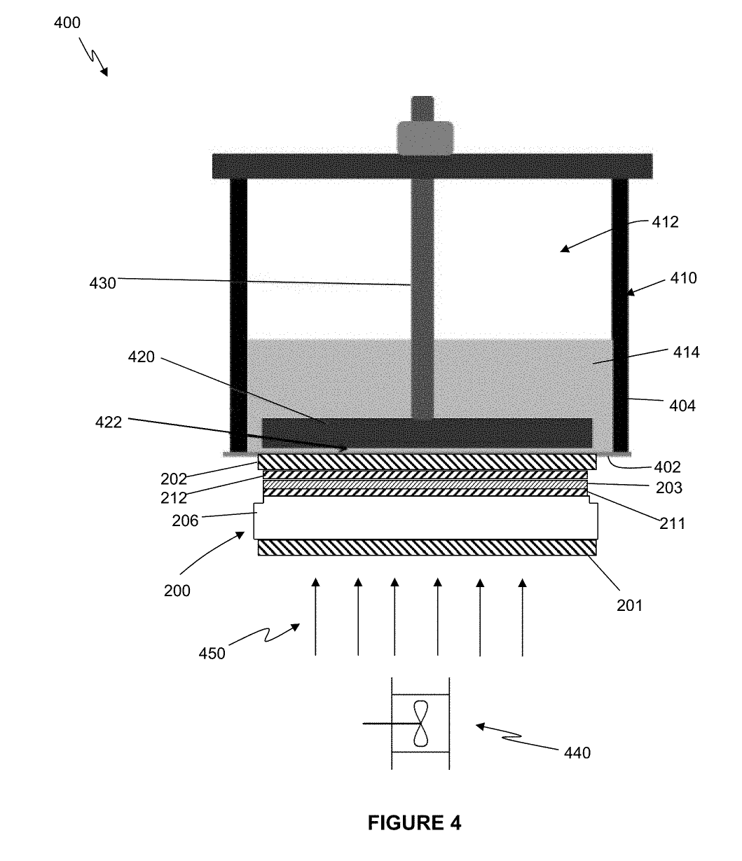

Referring now to FIG. 4, there is shown an additive manufacturing apparatus 400 incorporating the LCD assembly 200 of FIG. 2. The LCD assembly 200 is part of a curing assembly which also includes a radiation source 450. The radiation source 450 may be a UV lamp, for example.

The additive manufacturing apparatus 400 comprises a vessel 410 for containing a polymerizable material 414 in a curing volume 412. The vessel 410 has a transparent lower wall 402, sidewalls 404 and a seal between the transparent lower wall 402 and the sidewalls 404 of vessel 410. The seal may be formed from a material such as epoxy which is cured in situ to seal the vessel, but it could also be a solid seal such as a rubber (nitrile or viton, for example) O-ring or gasket. Preferably, the vessel 410 has four sidewalls defining a rectangular or square internal region, but it may of course have a single cylindrical sidewall or other configuration.

The LCD assembly 200 is positioned underneath the lower wall 402 such that the polarizer 202 contacts the lower wall 402. The rigid transparent member 206 provides the other layers 202, 212, 203, 211 with support when the LCD assembly 200 is in contact with the lower wall 402. In some embodiments, the LCD assembly may be attached to the lower wall 402 of the vessel 410. However, in alternative embodiments, the LCD assembly 200 may be located within or be integral to the vessel 410.

The apparatus 400 comprises a build platform 420 having a build surface 422. The build surface 422 faces towards the lower wall 402 of vessel 410. The build platform 420 is suspended inside the vessel 410 above the lower wall 402 and the LCD assembly 200.

Build platform 420 is capable of moving or being made to move vertically upward and downward relative to vessel 410 above the lower wall 402, by means of a mechanical assembly which may comprise ball screws, lead screws, belt drive mechanisms, a chain and sprocket mechanism, or a combination thereof, and a precision stepper motor. In a preferred embodiment, the movement mechanism comprises threaded rods 430 and a stepper motor, which is driven by a microcontroller of a control system of the device 400 (not shown).

In use during a build operation, radiation source 450 of the curing assembly irradiates the LCD assembly 200. Resin 414 in the vessel 410 is cured, layer-by-layer, in respective layer patterns which depends on the pattern of active pixels of LCD 203. Meanwhile, a cooling device 440, such as a blower or other convective cooling device, can be used to provide a cooling air flow over the polarizer 201, which is on the surface of the LCD assembly 200 facing the radiation source 450.

A variety of other variations and modifications which do not depart from the scope of the invention will be evident to persons of ordinary skill in the art from the disclosure herein. The following claims are intended to cover the specific embodiments set forth herein as well as such variations, modifications, and equivalents.

1. A liquid crystal display assembly, comprising:
a first substrate, a second substrate and a liquid crystal layer intermediate the first substrate and the second substrate;
a first polarizer having an inner surface which faces towards the first substrate, and an outer surface; and
a second polarizer disposed on the second substrate and having a plane of polarization orthogonal to that of the first polarizer;
wherein the inner surface of the first polarizer is spaced from the first substrate such that the inner surface and/or the outer surface is exposed to enable convective cooling thereof.

2. A liquid crystal display assembly according to claim 1, comprising a rigid and transparent or translucent backing layer on the first substrate.

3. A liquid crystal display assembly according to claim 2, comprising a third polarizer disposed on the first substrate, the third polarizer having the same plane of polarization as the first polarizer.

4. A liquid crystal display assembly according to claim 3, wherein the first polarizer is disposed on the transparent or translucent backing layer.

5. A liquid crystal display assembly according to claim 3, wherein the first polarizer is a dichroic polarizer.

6. A curing assembly for a stereolithographic apparatus having a curing volume for containing a polymerisable material, the curing assembly comprising:
a liquid crystal display assembly comprising:
a first substrate, a second substrate and a liquid crystal layer intermediate the first substrate and the second substrate;
a first polarizer having an inner surface which faces towards the first substrate, and an outer surface; and
a second polarizer disposed on the second substrate and having a plane of polarization orthogonal to that of the first polarizer;
wherein the inner surface of the first polarizer is spaced from the first substrate such that the inner surface and/or the outer surface is exposed to enable convective cooling thereof; and a radiation source for irradiating the curing volume through the liquid crystal display assembly.

7. A curing assembly according to claim 6, comprising cooling means for convective cooling of the inner surface and/or the outer surface of the first polarizer of the liquid crystal display assembly.

8. A method of arranging components of a liquid crystal display assembly, the liquid crystal display assembly comprising a first substrate, a second substrate, a liquid crystal layer intermediate the first substrate and the second substrate, a first polarizer, and a second polarizer having a plane of polarization orthogonal to that of the first polarizer, the method comprising:
disposing the second polarizer on the second substrate; and
spacing the first polarizer from the first substrate whereby an inner surface of the first polarizer faces towards the first substrate, such that the inner surface and/or outer surface of the first polarizer is exposed to enable convective cooling thereof.

9. A curing assembly according to claim 2, wherein the first polarizer is disposed on the transparent or translucent backing layer.

10. A curing assembly according to claim 1, wherein the liquid crystal display assembly comprises a rigid and transparent or translucent backing layer on the first substrate comprising a third polarizer disposed on the first substrate, the third polarizer having the same plane of polarization as the first polarizer.

11. A curing assembly according to claim 10, wherein the first polarizer is a dichroic polarizer.

12. A curing assembly according to claim 6, wherein the liquid crystal display assembly comprises a rigid and transparent or translucent backing layer on the first substrate.

13. A curing assembly according to claim 12, wherein the liquid crystal display assembly comprises a third polarizer disposed on the first substrate, the third polarizer having the same plane of polarization as the first polarizer.

14. A curing assembly according to claim 13, wherein the first polarizer is disposed on the transparent or translucent backing layer.

15. A curing assembly according to claim 13, wherein the first polarizer is a dichroic polarizer.

16. A curing assembly according to claim 6, wherein the first polarizer is disposed on the transparent or translucent backing layer.

17. A curing assembly according to claim 6, wherein the liquid crystal display assembly comprises a third polarizer disposed on the first substrate, the third polarizer having the same plane of polarization as the first polarizer.

18. A curing assembly according to claim 17, wherein the first polarizer is a dichroic polarizer.
